(19) United States
(12) Patent Application Publication
(10) Pub. No.: US 2015/0258937 A1
(43) Pub. Date: Sep. 17, 2015

(54) VEHICLE WITH BLIND SPOT MONITOR DEVICE

(71) Applicant: Chi-Yuan WEN, New Taipei City (TW)

(72) Inventor: Chi-Yuan WEN, New Taipei City (TW)

(21) Appl. No.: 14/656,457

(22) Filed: Mar. 12, 2015

(30) Foreign Application Priority Data
Mar. 14, 2014 (TW) 103204434

(51) Int. Cl. B60R 1/00

(52) U.S. Cl. CPC B60R 1/002; B60R 2300/406; B60R 2300/802

(57) ABSTRACT

device vehicle includes a pillar, a driver seat and a blind spot monitor device including a camera module, a display module and a mounting component. The camera module includes a camera disposed to substantially face a direction along a line of sight of a driver who sits in the driver seat toward the pillar and operable to capture an image of a blind spot attributed to the pillar and to output an image data signal. The display module includes a display coupled to the camera module for receiving the image data signal and operable to display the image of the blind spot according to the image data signal. The mounting component supports the display module at a position within the line of sight of the driver toward the pillar.

### CROSS-REFERENCE TO RELATED APPLICATION

This application claims priority of Taiwanese Application No. 103204434, filed on Mar. 14, 2014.

### FIELD

The present disclosure relates to a vehicle, more particularly to a vehicle provided with a blind spot monitor device for monitoring a blind spot that is attributed to a pillar of the vehicle.

### BACKGROUND

Nowadays, a driver's poor sight is one of the major reasons to cause traffic accidents, especially as resulted from block of windshield pillars (A-pillar).

### SUMMARY

Therefore, an object of the present disclosure is to provide a vehicle with a blind spot monitor device that is configured to monitor a blind spot attributed to a pillar of the vehicle.

Accordingly, a vehicle of the present disclosure includes a pillar, a driver seat, and a blind spot monitor device that includes a camera module, a display module and a mounting component.

The camera module includes a camera. The camera is disposed to substantially face a direction along a line of sight of a driver sitting in the driver seat toward the pillar. The camera is operable to capture an image of a blind spot attributed to the pillar and to output an image data signal representing the image of the blind spot.

The display module includes a display. The display is coupled to the camera module for receiving the image data signal and is operable to display the image of the blind spot according to the image data signal.

The mounting component supports the display module at a position within the line of sight of the driver toward the pillar.

### BRIEF DESCRIPTION OF THE DRAWINGS

Other features and advantages of the present disclosure will become apparent in the following detailed description of the embodiments with reference to the accompanying drawings, of which:

FIG. 1 is a schematic diagram of a blind spot monitor device of a vehicle according to a first embodiment of the present disclosure;

FIG. 2 is a partial schematic view of the first embodiment for illustrating a position a mounting component of the blind spot monitor device is mounted;

FIG. 3 is a schematic view of the mounting component of the first embodiment;

FIG. 4 is a schematic diagram of a variation of the blind spot monitor device of the first embodiment;

FIG. 5 is a schematic diagram of another variation of the blind spot monitor device of the first embodiment;

FIG. 6 is a partial schematic view of the first embodiment for illustrating a direction a camera module of the blind spot monitor device faces;

FIG. 7 is a schematic diagram of a blind spot monitor device according to a second embodiment of the present disclosure;

FIG. 8 is a partial schematic diagram of a different implementation of the first embodiment;

FIG. 9 is a partial schematic view of the implementation of the first embodiment as depicted in FIG. 8, for illustrating a direction the camera module faces;

FIG. 10 is a partial schematic diagram of a third embodiment of a vehicle according to the present disclosure;

FIG. 11 is a partial schematic view of the mounting component of the blind spot monitor device according to the third embodiment;

FIG. 12 is a partial schematic diagram of a fourth embodiment of a vehicle according to the present disclosure; and

FIG. 13 is a partial schematic view of the mounting component according to the fourth embodiment.

### DETAILED DESCRIPTION

Before the present disclosure is described in greater detail, it should be noted that like elements are denoted by the same reference numerals throughout the disclosure.

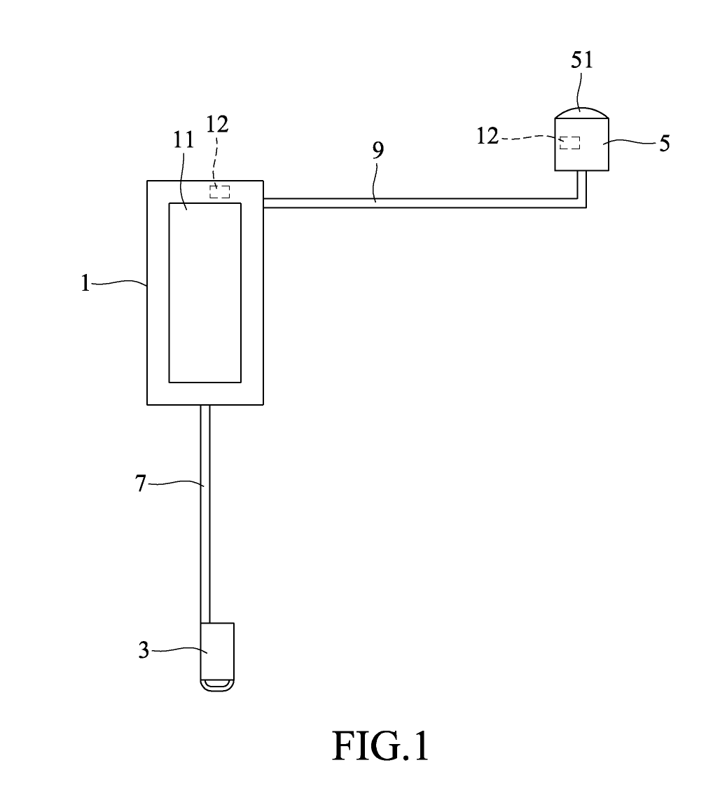

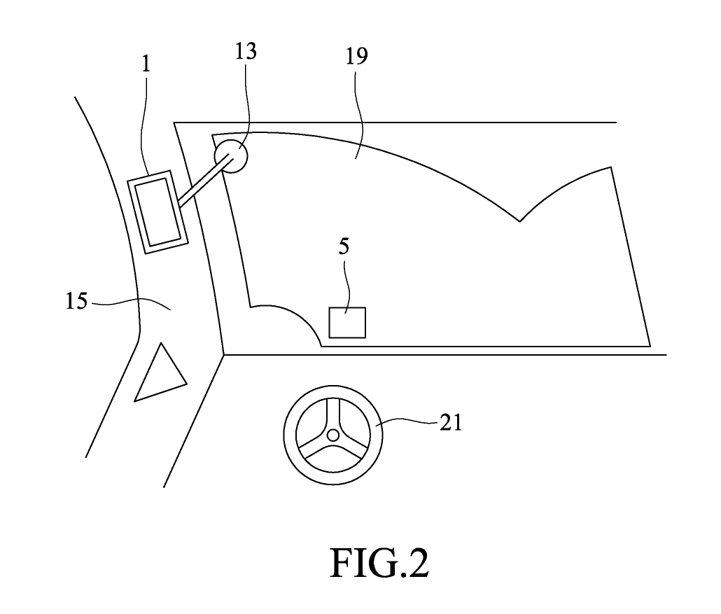

Referring to FIGS. 1, 2 and 3, a first embodiment of a vehicle according to the present disclosure includes a pillar 15 (e.g., a windshield pillar or A-pillar), a windshield 19, a driver seat with a steering wheel 21, an electric power source (not shown) and a blind spot monitor device. The blind spot monitor device includes a display module 1, an electrical connector 3, a camera module 5 and a mounting component 13.

The camera module 5 is connected electrically to the display module 1 via an electric cable 9. The camera module 5 includes a camera 51 that is operable to capture an image of a blind spot attributed to the pillar 15 and to output an image data signal that represents the image of the blind spot. The camera 51 could be one of a CCD camera, a CMOS camera and an infrared camera. Meanwhile, the camera module 5 is connected electrically to the electric power source.

The electrical connector 3 is connected electrically to the display module 1 via an electric cable 7 and is connected electrically to the electric power source. The electric power source is for supplying electric power to the display module 1 and the camera module 5.

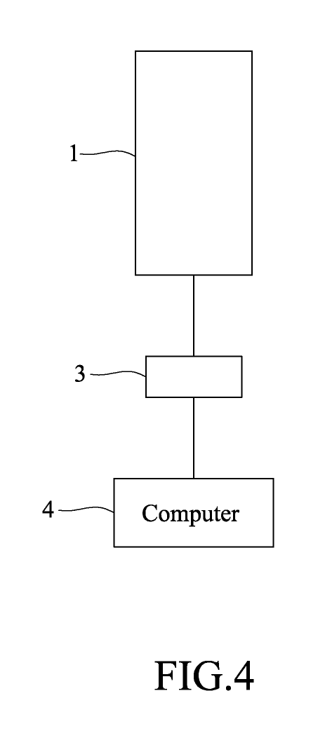

In this embodiment, the electrical connector 3 is in the form of a cigarette lighter plug. The electrical power source of the vehicle is a cigarette lighter receptacle of the vehicle. The cigarette lighter plug is configured to be inserted into the cigarette lighter receptacle of the vehicle. However, in other embodiments of the present disclosure, referring to FIG. 4, the electrical connector 3 may be an electric cable and the electrical power source maybe a computer of the vehicle. Therefore, the electric power and vehicle information maybe transmitted from the electric power source (i.e., the computer of the vehicle) to the display module 1 through the electrical connector 3 (i.e., the electric cable). The vehicle information may be speed of the vehicle, temperature of a water tank, remaining fuel, and so on, but should not be limited thereto.

The display module 1 includes a display 11 that is coupled to the camera module 5 for receiving the image data signal therefrom and that is operable to display the image of the blind spot according to the image data signal. In addition, the display 11 is also operable to display the vehicle information. In this embodiment, the display 11 may be one of a TFT display panel, an LCD display panel, an OLED display panel, a bendable display panel, a resistive touch panel and a capacitive touch panel.

In this embodiment, each of the display module 1 and the camera module 5 has a storage device 12 disposed therein for storing images captured by the camera 51. However, in other embodiments of the present disclosure, the storage device 12 may be provided in at least one of the display module 1 and the camera module 5.

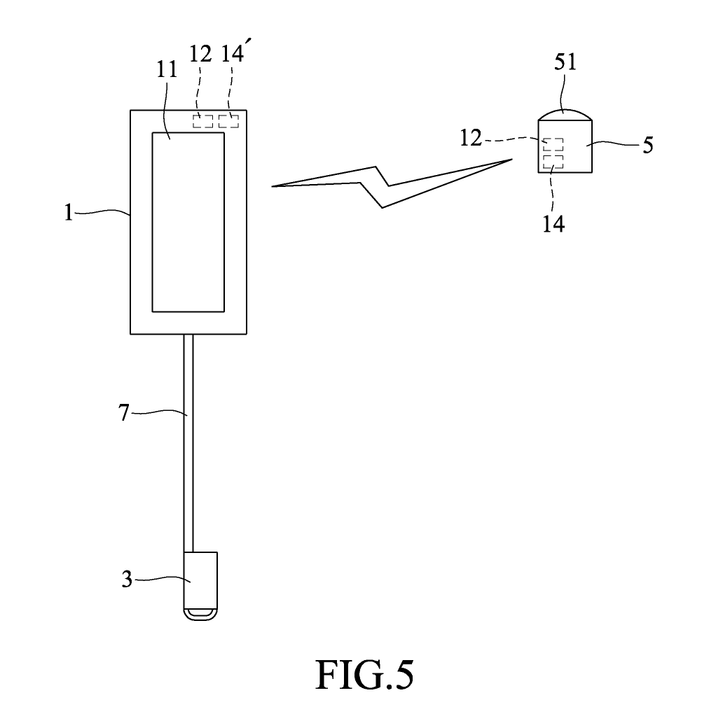

It is understood that a data signal transmission between the camera module 5 and the display module 1 may also be achieved by technique of wireless transmission (e.g., Bluetooth transmission) instead of the electric cable 9 that is connected electrically between the camera module 5 and the display module 1. Specifically, as shown in FIG. 5, the camera module 5 includes a Bluetooth transmitter 14, and the display module 1 includes a Bluetooth receiver 14′. In this case, the camera 51 of the camera module 5 outputs the image data signal that represents the image of the blind spot for transmission by the Bluetooth transmitter 14 to the Bluetooth receiver 14′ of the display device 1.

In this embodiment, the driver seat and steering wheel 21 of the vehicle is disposed on the left-hand side.

The mounting component 13 is mounted to an inner side of the windshield 19 and supports the display module 1 in a manner that the display module 1 is hanging. However, the mounting component 13 may also be mounted to one of the windshield pillars 15 that is near the driver seat and steering wheel 21.

The camera 51 of the camera module 5 is disposed at the inner side of the windshield 19 within a wiping range of a windshield wiper (not shown) of the vehicle.

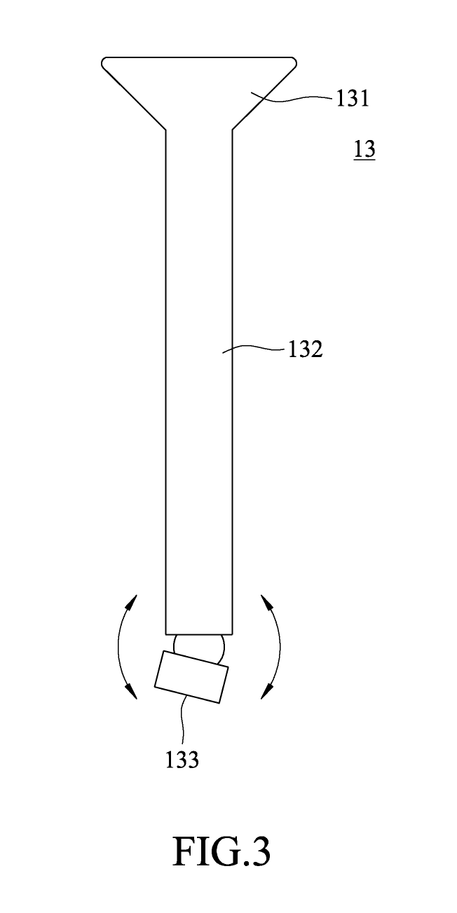

As shown in FIG. 3, the mounting component 13 includes a mounting base 131, a connecting arm 132 and a universal joint 133. The mounting base 131 is configured to be mounted to the windshield 19 in this embodiment, but may also be mounted to one of the windshield pillars 15 in other embodiments of the present disclosure. The connecting arm 132 is connected between the mounting base 131 and the universal joint 133. The universal joint 133 is connected to the display module 1. As indicated by double-headed arrows in FIG. 3, the universal joint 133 of the mounting component 13 may adjust rotatably the display module 1 to face any desired direction. It is understood that the illustrated mounting component 13 is merely an example and the present disclosure should not be limited thereto. In this embodiment, the mounting base 131 may be one of a sucker, an adhesive element, a fastening element, and so on, but should not be limited thereto.

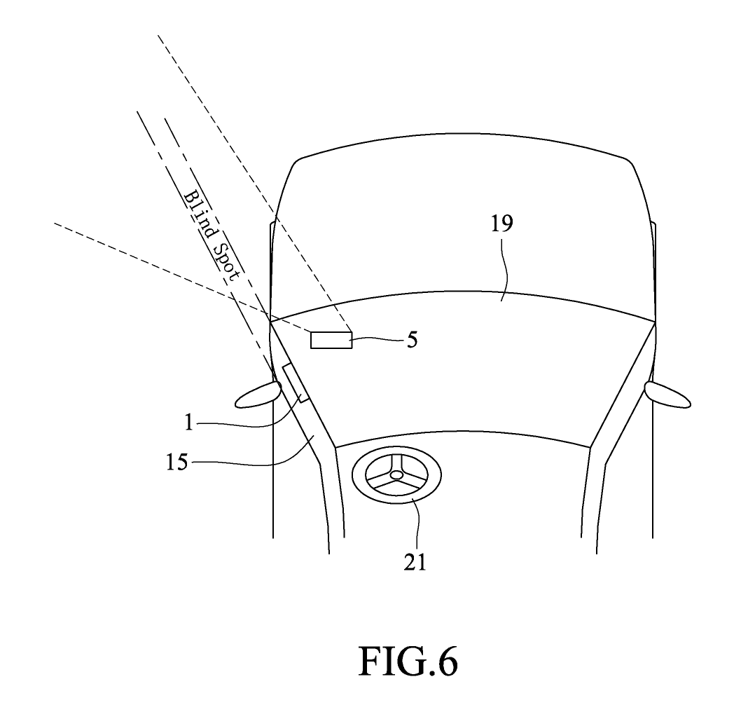

Referring to FIG. 6, the camera 51 of the camera module 5 is disposed at the inner side of the windshield 19 within the wiping range of the windshield wiper, is disposed to substantially face a direction along a line of sight of the driver sitting on the driver's seat toward the pillar 15, and is operable to capture the image of the blind spot and to output the image data signal representing the image of the blind spot. The display 11 of the display module 1 is operable to display the image of the blind spot according to the image data signal.

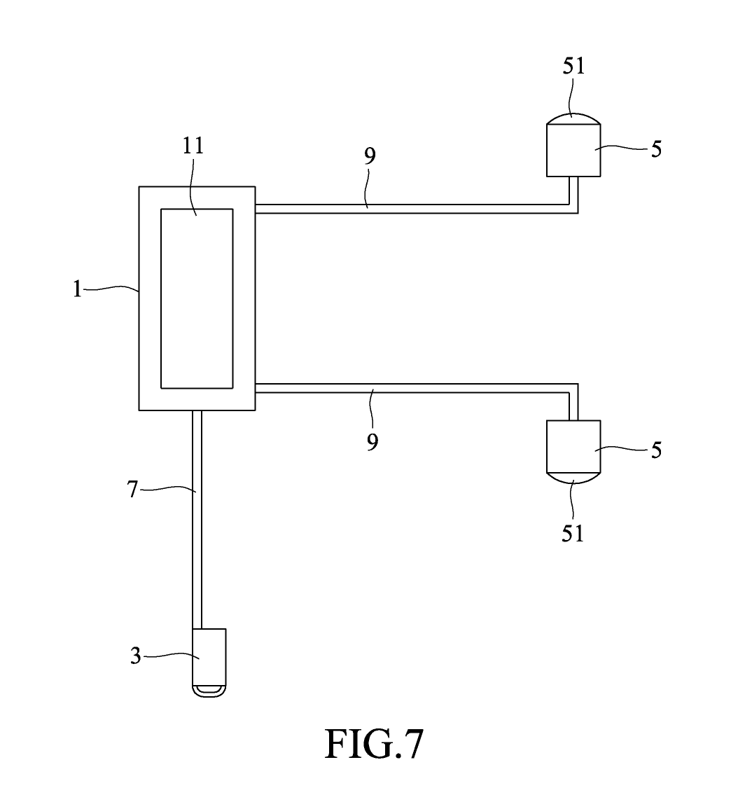

Referring to FIG. 7, the blind spot monitor device according to a second embodiment of the present disclosure is similar to that of the first embodiment. The only difference resides in that the blind spot monitor device in this embodiment includes two camera modules 5. It is noted that the configuration of the two camera modules 5 in this embodiment may capture a wider range of the blind spot than the first embodiment. In other embodiments of the present disclosure, the camera modules 5 may be connected electrically to the display module 1 through the same electric cable 9, thereby reducing occupied space. By virtue of the second embodiment, a similar effect of the first embodiment may also be achieved.

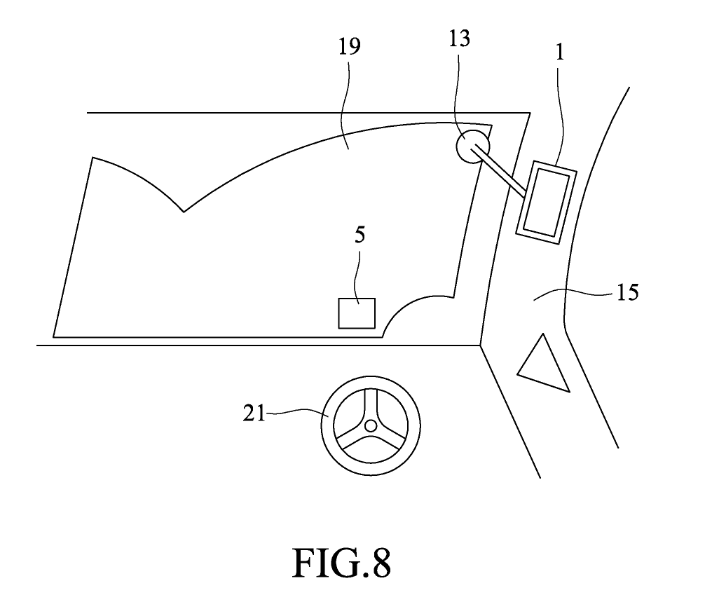

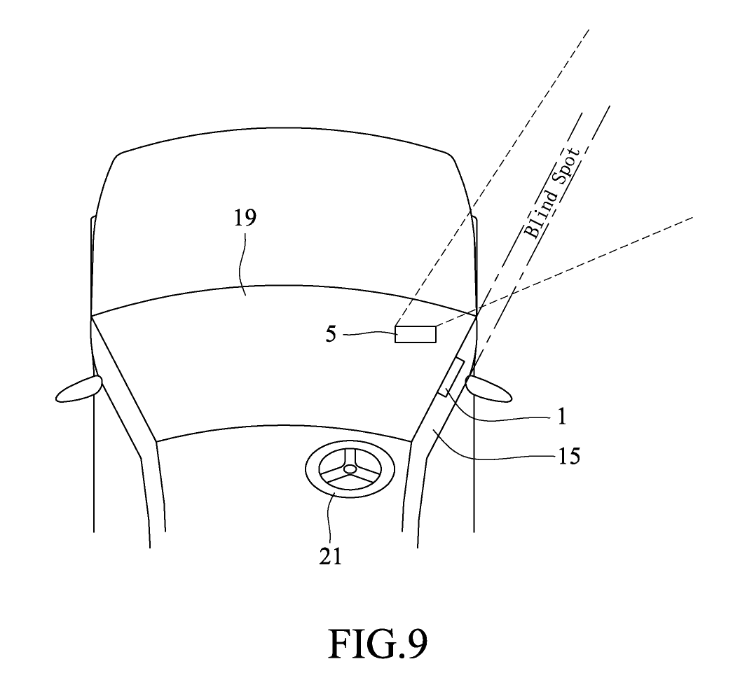

Shown in FIGS. 8 and 9 is an implementation of the first embodiment in which the driver seat and steering wheel 21 is disposed at the right-hand side of the vehicle.

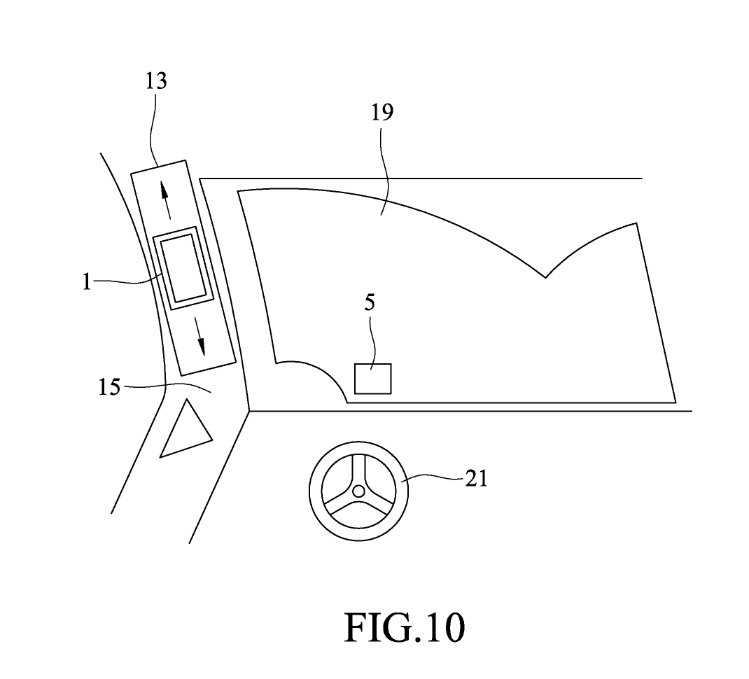

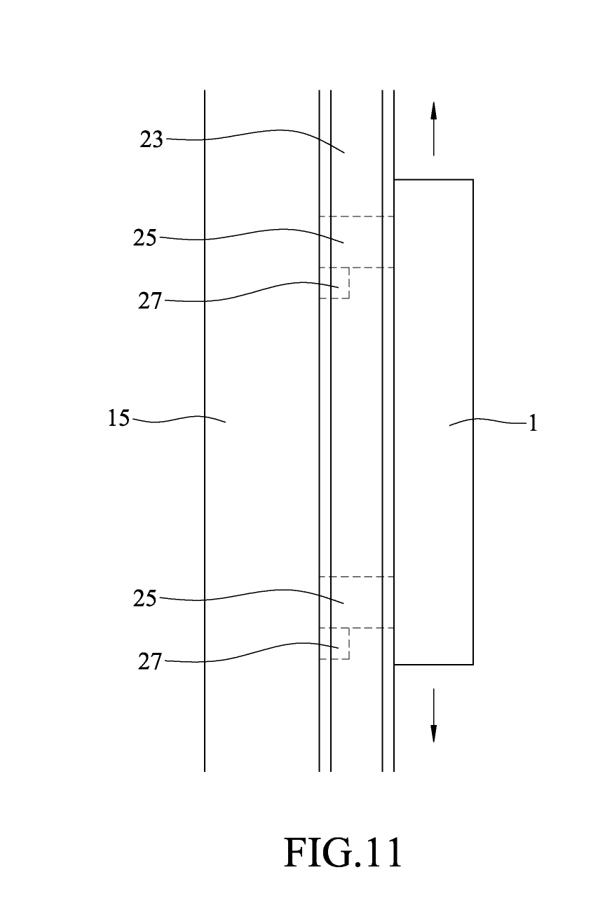

Referring to FIGS. 10 and 11, a third embodiment of the vehicle according to the present disclosure is similar to the first embodiment. The only difference resides in that the mounting component 13 of the blind spot monitor device in this embodiment is mounted to inside the pillar 15 to support the display module 1.

In this embodiment, the display module 1 may be adjusted to a desired position through the mounting component 13 as indicated by arrows in FIGS. 10 and 11.

The mounting component 13 includes a track 23, a sliding block 25 and a fastening member 27. The sliding block 25 is disposed in the track 23, is connected to the display module 1, and is slidable along the track 23 as indicated by the arrows so as to adjust the display module 1 to the desired position. The fastening member 27 (e.g., a latch, a buckle, etc.) is connected to the sliding block 25 for securing the sliding block 25 at the desired position on the track 23. In this embodiment, the track 23 is mounted to an outer surface of the pillar 15 so that the display module 1 is hanging. By virtue of the third embodiment, a similar effect of the first embodiment may also be achieved.

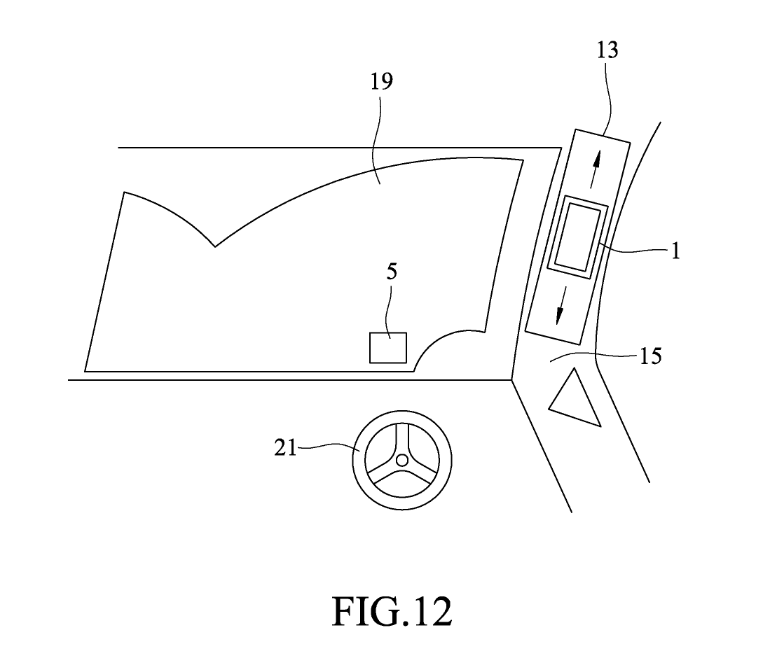

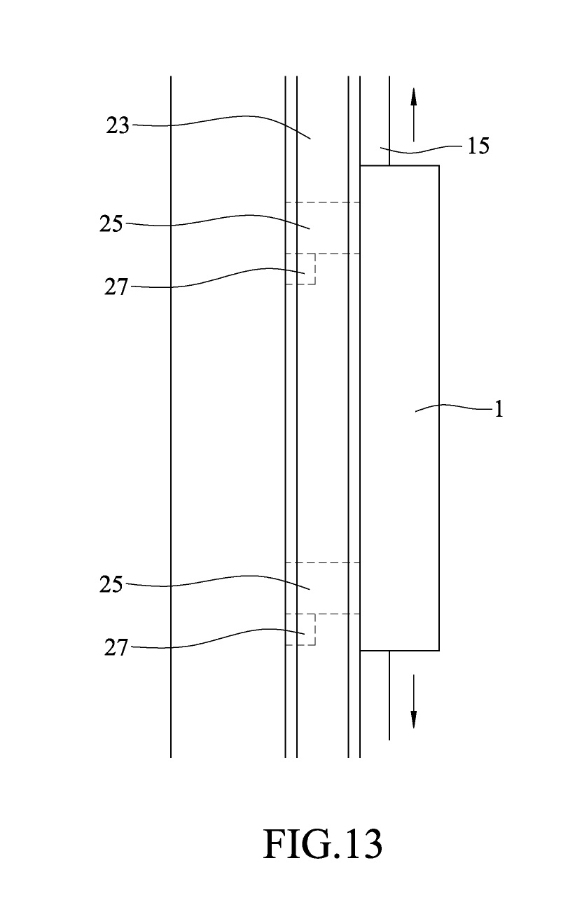

Referring to FIGS. 12 and 13, a fourth embodiment of the vehicle according to the present disclosure is similar to the third embodiment. The differences reside in that: the driver seat and steering wheel 21 is disposed at the right-hand side of the vehicle; and the track 23 is deeper in the pillar 15 so that the display device 1 is at least partially embedded in the pillar 15, thereby increasing available space inside the vehicle. By virtue of the fourth embodiment, a similar effect of the first embodiment may also be achieved.

To conclude, with the camera 51 substantially facing a direction along a line of sight of the driver sitting on the driver seat the pillar 15 of the vehicle, and capturing images of the blind spot, and the display 11 displaying the images, the safety of driving may be increased.

While the present disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A vehicle, comprising:
a pillar;
a driver seat; and
a blind spot monitor device that includes
a camera module including a camera that is disposed to substantially face a direction along a line of sight of a driver sitting in said driver seat toward said pillar, and that is operable to capture an image of a blind spot attributed to said pillar and to output an image data signal representing the image of the blind spot,
a display module including a display that is coupled to said camera module for receiving the image data signal and that is operable to display the image of the blind spot according to the image data signal, and
a mounting component supporting said display module at a position within the line of sight of the driver toward said pillar.

2. The vehicle as claimed in claim 1, further comprising a windshield;
wherein said camera module of said blind spot monitor device is disposed at an inner side of said windshield within a wiping range of a windshield wiper.

3. The vehicle as claimed in claim 1, further comprising an electric power source;
wherein said blind spot monitor device further includes an electrical connector that is electrically connected between said display module and said electric power source for supplying electric power from said electric power source to said display module.

4. The vehicle as claimed in claim 3, further comprising a computer;
wherein said electrical connector is electrically connected to said computer that serves as said electric power source for transmitting vehicle information from said computer to said display module; and
wherein said display of said display module is further operable to display the vehicle information.

5. The vehicle as claimed in claim 1, further comprising a windshield;
wherein said mounting component of said blind spot monitor device includes a mounting base mounted to an inner side of said windshield, a connecting arm connected to said mounting base, and a universal joint connected between said connecting arm and said display module for supporting said display module near said pillar.

6. The vehicle as claimed in claim 1, wherein said mounting component of said blind spot monitor device includes:
a track;
a sliding block disposed in said track, being slidable along said track, and connected to said display module; and
a fastening member connected to said sliding block for positioning said sliding block on said track.

7. The vehicle as claimed in claim 6, wherein said track is embedded in said pillar.

8. The vehicle as claimed in claim 1, wherein said camera module of said blind spot monitor device further includes a wireless signal transmitter for transmitting the image data signal, and said display module of said blind spot monitor device further includes a wireless signal receiver for receiving the image data signal from said wireless signal transmitter.

9. The vehicle as claimed in claim 8, wherein said wireless signal transmitter is a Bluetooth transmitter, and said wireless signal receiver is a Bluetooth receiver.
